(19) United States
(12) Patent Application Publication
(10) Pub. No.: US 2004/0250818 A1
(43) Pub. Date: Dec. 16, 2004

(54) Mouthguard fitting tool

(76) Inventors: William A. Cook, Lakeville, MN (US); Mark Herman, Minneapolis, MN (US)

Correspondence Address: BRIGGS AND MORGAN, P.A., 2200 IDS CENTER, MINNEAPOLIS, MN, 55402, US

(21) Appl. No.: 10/460,892

(22) Filed: Jun. 12, 2003

(51) Int. Cl. A61C 5/14

(52) U.S. Cl. 128/861

(57) ABSTRACT

A tool for fitting a mouthguard in the mouth of a wearer consists of a mouthguard holding section; a flexible, positioning handle section; a first finger guide; and one or more second finger guides. The mouthguard holding section and the flexible, positioning handle section are molded as one “shot” during injection molding. The first finger guide and the second finger guides are molded as a second “shot.”

### BACKGROUND OF THE INVENTION

The present invention relates generally to protective mouthguards for use in athletics and more particularly, to a mouthguard fitting tool which will assist in heating, positioning and aligning a thermoplastic mouthguard to custom fit a user's mouth.

A number of mouthguards currently exist in the art for protecting the teeth and for reducing the chance of shock, concussions and other injuries as a result of high impact collisions and blows during athletic competition. Mouthguards generally are characterized as being nonpersonalized, universal and stock model type, or are customized to have direct upper jaw tooth-formed contact. Additionally, the mouthguards may be tethered or untethered. Mouthguards that are to be tethered may be fastened to a helmet or face guard to prevent the chance of the mouthguard from being lost as well as to prevent swallowing of the mouthguard or choking on the mouthguard by the user. Custom mouthguards that are personalized for the individual wearer or user may be created by technicians, practitioners or dentists. Alternatively, users, as well as dentists, may create custom fit mouthguards to have direct contact with the teeth, gums and jaws by way of the boil-and-bite method. Ethylene vinyl acetate (EVA) material works suitably well as a thermoplastic material for mouthguards. The EVA mouthguard will readily soften when submerged in boiling water momentarily after which the mouthguard may be removed and fitted about the user's upper jaw, teeth and gums after which the user applies contact pressure as well as suction to custom fit the mouthguard to the upper jaw.

The most common problem with EVA-like material mouthguards that are to be heated and then fitted to the user is that the heated mouthguards become limp and completely lose their shape upon heating. A heated, limp mouthguard is difficult to fit within the user's mouth and quickly form about the user's upper jaw in a timely fashion before the EVA-like material becomes stiff or hard. This problem becomes even more heightened when the particular mouthguard design is further customized to have additional features, such as occlusal pads, or an anterior impact brace which must be properly aligned and positioned.

Further still, dentists, team doctors, practitioners and equipment personnel have had an increasing concern for the temporo mandibular joint (TMJ) and protecting the TMJ from injury. Consequently, the alignment and positioning of the lower jaw and indexing of the lower jaw upon the softened mouthguard to be formed have all recently been receiving additional attention and consideration.

U.S. Pat. No. 5,320,114 (Kittelsen et.al.) discloses a boiling and stabilization tray for mouthguards. This device does not provide optimal fitting of a mouthguard because it is not flexible and does not adjust to the teeth during the fitting process. Also, the device does not provide finger guides which can be used to hold and position the device during fitting. Furthermore, the device positions the user's hands too close to steam rising from the softening liquid.

There is a need for a mouthguard fitting tool for use in heating, positioning and aligning thermoplastic mouthguards to custom fit a user's mouth. The fitting tool should receive and support the mouthguard for heating and further permit quick and accurate positioning and aligning of the heated and softened thermoplastic mouthguard to permit custom fitting with respect to all of the above mouthguard features.

### SUMMARY OF THE INVENTION

A tool for fitting a mouthguard, comprising:

(a) a mouthguard holding section;

(b) a flexible, positioning handle section having a first end adjacent the mouthguard holding section and a second end;

(c) a first finger guide adjacent the second end; and

(d) a second finger guide between the first end and the second end.

A principal object and advantage of the present invention is that the flexible, positioning handle section may be flexed in two dimensions to assist in positioning the mouthguard in the wearer's mouth.

Another principal object and advantage of the present invention is that the first finger guide is far enough from the mouthguard as to keep the wearer's fingers away from steam rising from the boiling water used to soften the mouthguard.

Another principle object and advantage of the present invention is that the second finger guides can be used to more accurately position the mouthguard in the wearer's mouth.

Another principle object and advantage of the present invention is that the second finger guides have a “soft touch” which is pleasant to use.

Another principle object and advantage of the present invention is that the 10various parts of the tool can be molded together as “shots” during injection molding.

### BRIEF DESCRIPTION OF DRAWINGS

FIG. 1 is a perspective view of the mouthguard fitting tool of the present invention.

FIG. 2 is a front elevational view of the mouthguard fitting tool of the present invention.

FIG. 3 is a rear elevational view of the mouthguard fitting tool of the present invention.

FIG. 4 is a bottom plan view of the mouthguard fitting tool of the present invention with an alternative position shown in dashed lines.

FIG. 5 is a side elevational view of the mouthguard fitting tool of the present invention with an alternative position shown in dashed lines.

FIG. 6 is a top plan view of the mouthguard fitting tool of the present invention.

FIG. 7 is a side elevational view of the mouthguard fitting tool of the present invention.

FIG. 8 is a cross-section of the mouthguard fitting tool of the present invention taken at approximately the lines 8 of FIG. 7.

FIG. 9 is a schematic of the mouthguard fitting tool of the present invention, showing the use of the invention in softening a mouthguard in boiling water.

FIG. 10 is a schematic of the mouthguard fitting tool of the present invention, showing the use of the invention in fitting a moutguard in the mouth of a wearer.

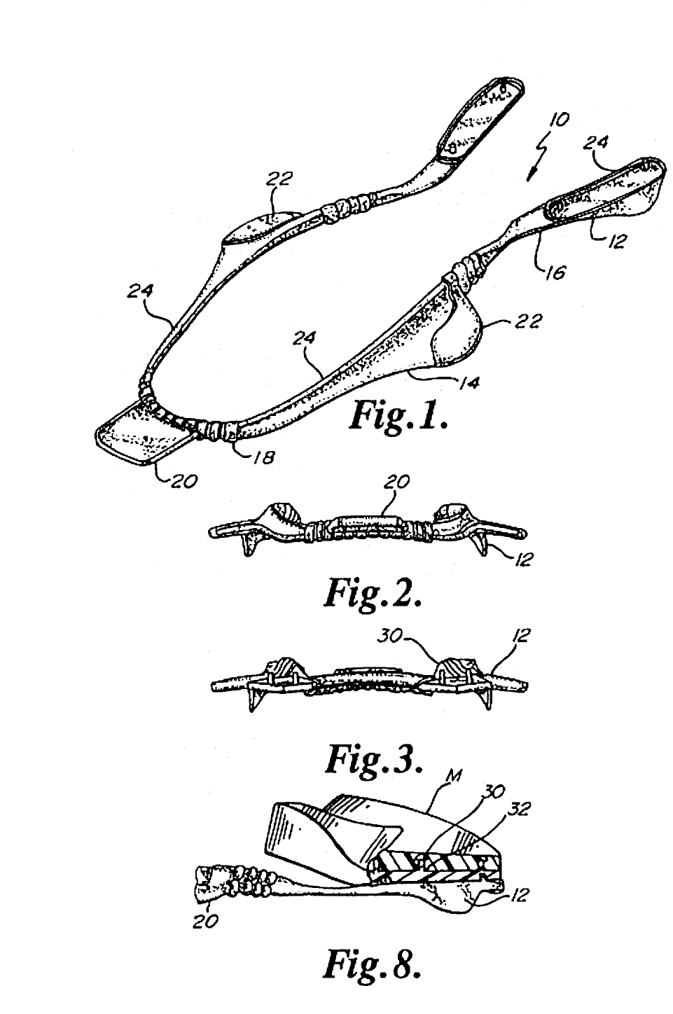

### DETAILED DESCRIPTION OF THE PREFERRED EMBODIMENT

The mouthguard fitting tool of the present invention is generally shown in the Figures as reference numeral 10.

The mouthguard fitting tool 10 comprises a mouthguard holding section 12, a flexible, positioning handle section 14 having a first end 16 adjacent the mouthguard holding section 12 and a second end 18, a first finger guide 20 adjacent the second end 18, and a second finger guide 22 between the first end 16 and the second end 18.

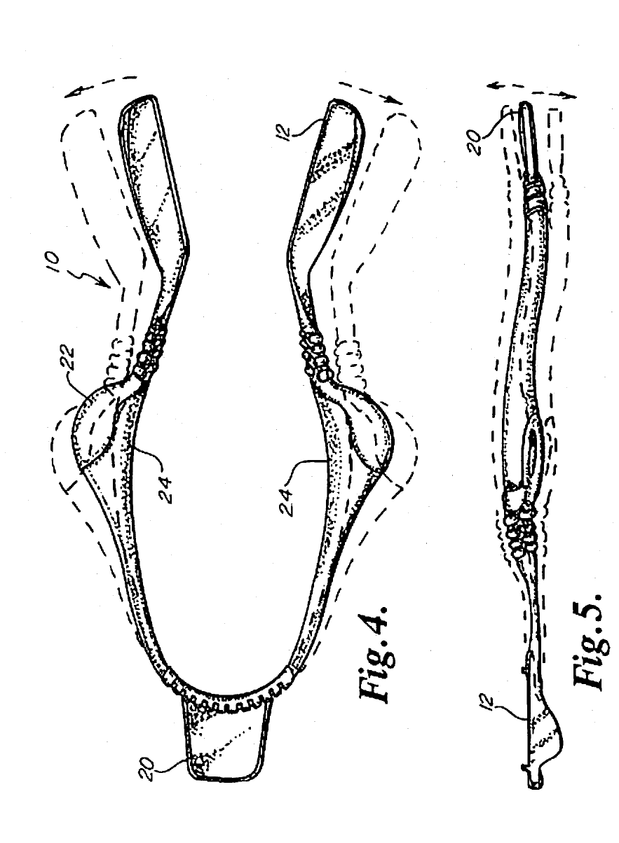

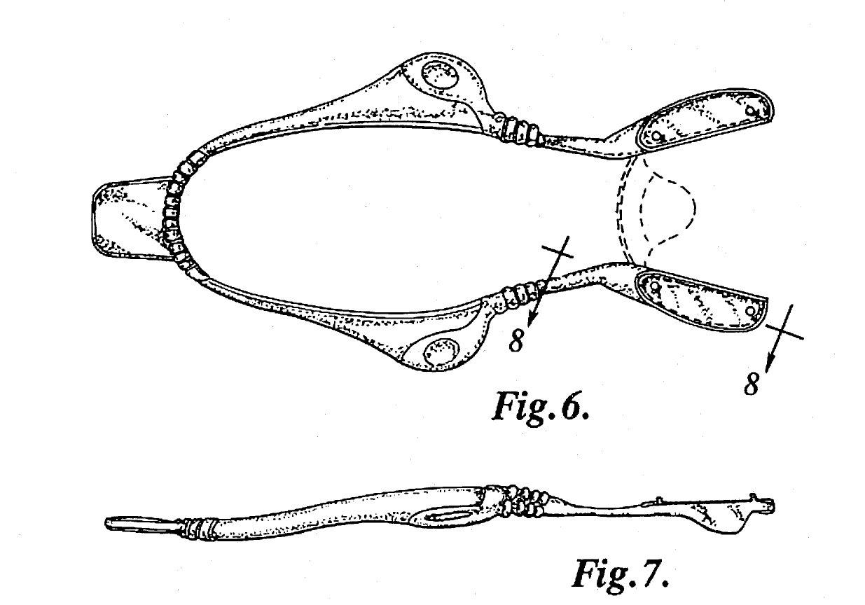

In one embodiment, the flexible, positioning handle section 14 flexes in two dimensions, as shown by the dashed lines in FIGS. 4 and 5.

In one embodiment, the flexible, positioning handle section 14 further comprises a pair of flexible arms 24.

In one embodiment, the flexible arms 24 are conjoined at the second end 18.

In one embodiment, the flexible, positioning handle section 14 and the mouthguard holding section 12 are molded together as a single unit.

In one embodiment, the flexible, positioning handle section 14 and the mouthguard holding section 12 are molded from polypropylene.

In one embodiment, the first finger guide 20 and the second finger guide 22 are molded to the flexible, positioning handle section 14.

In one embodiment, the first finger guide 20 and the second finger guide 22 are molded from a soft-touch, thermoplastic elastomer alloy.

The material from which the flexible, positioning handle section 14 and the mouthguard holding section 12 is molded may be obtained as SR549M polypropylene from Basell Polyolefins through the distributor Ashland Distribution Company, 5200 Blazer Parkway, Dublin, Ohio 43017.

The material from which the first finger guide 20 and the second finger guide 22 are molded may be obtained as Versaflex® CL30 Thermoplastic Elastomer Alloy from GLS Corporation, 833 Ridgeview Drive, McHenry, Ill. 60050.

To fit the mouthguard, the wearer mounts the mouthguard to the tool 10 at the mouthguard holding section 12. In one embodiment, the mouthguard holding section 12 has raised portions 30 which mate with receiving apertures 32 in the mouthguard M, as best seen in FIG. 8. However, any equivalent mounting mechanism may be used.

After mounting the mouthguard to the mouthguard holding section 12, the user dips the mouthguard M into boiling water, as shown in FIG. 9, thus softening the mouthguard M. Appropriately, the wearer may grip the tool 10 at the first finger guide 20. In this manner, the wearer's fingers are kept clear of any steam rising from the boiling water.

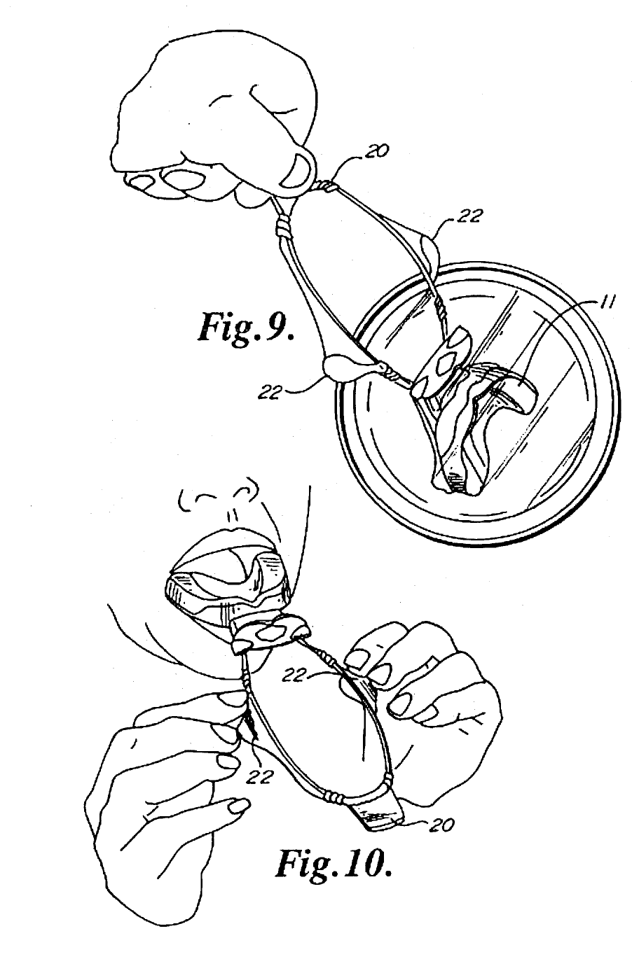

Next, the wearer appropriately holds the tool 10 using the second finger guide 22 (there may be a pair of such finger guides 22 as shown in FIG. 10). The wearer may flex the flexible, positioning handle section 14 in two dimensions to position the mouthguard M against his teeth.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A tool for fitting a mouthguard, comprising:
(a) a mouthguard holding section;
(b) a flexible, positioning handle section having a first end adjacent the mouthguard holding section and a second end;
(c) a first finger guide adjacent the second end; and
(d) a second finger guide between the first end and the second end.

2. The tool of claim 1, wherein the flexible, positioning handle section flexes in two dimensions.

3. The tool of claim 1, wherein the handle section further comprises a pair of flexible arms.

4. The tool of claim 3, wherein the flexible arms are conjoined at the second end.

5. The tool of claim 1, wherein the flexible, positioning handle section and the mouthguard holding section are molded together as a single unit.

6. The tool of claim 5, wherein the flexible, positioning handle section and the mouthguard holding section are molded from polypropylene.

7. The tool of claim 1, wherein the first finger guide and the second finger guide are molded to the flexible, positioning handle section.

8. The tool of claim 7, wherein the first finger guide and the second finger guide are molded from a soft-touch, thermoplastic elastomer alloy.

9. A tool for fitting a mouthguard, comprising:
(a) a mouthguard holding section;
(b) a flexible, positioning handle section having a first end adjacent the mouthguard holding section and a second end;
(c) a first finger guide adjacent the second end; and
(d) a second finger guide between the first end and the second end,
wherein the flexible, positioning handle section flexes in two dimensions.

10. The tool of claim 9, wherein the handle section further comprises a pair of flexible arms.

11. The tool of claim 10, wherein the flexible arms are conjoined at the second end.

12. The tool of claim 9, wherein the flexible, positioning handle section and the mouthguard holding section are molded together as a single unit.

13. The tool of claim 12, wherein the flexible, positioning handle section and the mouthguard holding section are molded from polypropylene.

14. The tool of claim 9, wherein the first finger guide and the second finger guide are molded to the flexible, positioning handle section.

15. The tool of claim 14, wherein the first finger guide and the second finger guide are molded from a soft-touch, thermoplastic elastomer alloy.

16. A tool for fitting a mouthguard, comprising:
(a) a mouthguard holding section;
(b) a flexible, positioning handle section having a first end adjacent the mouthguard holding section and a second end;
(c) a first finger guide adjacent the second end; and
(d) a second finger guide between the first end and the second end,
wherein the flexible, positioning handle section flexes in two dimensions, and wherein the handle section further comprises a pair of flexible arms.

17. The tool of claim 16, wherein the flexible arms are conjoined at the second end.

18. The tool of claim 16, wherein the flexible, positioning handle section and the mouthguard holding section are molded together as a single unit.

19. The tool of claim 18, wherein the flexible, positioning handle section and the mouthguard holding section are molded from polypropylene.

20. The tool of claim 16, wherein the first finger guide and the second finger guide are molded to the flexible, positioning handle section.

21. The tool of claim 20, wherein the first finger guide and the second finger guide are molded from a soft-touch, thermoplastic elastomer alloy.

22. A tool for fitting a mouthguard, comprising:
(a) a mouthguard holding section;
(b) a flexible, positioning handle section having a first end adjacent the mouthguard holding section and a second end;
(c) a first finger guide adjacent the second end; and
(d) a second finger guide between the first end and the second end,
wherein the flexible, positioning handle section flexes in two dimensions, wherein the handle section further comprises a pair of flexible arms,
wherein the flexible, positioning handle section and the mouthguard holding section are molded together as a single unit, and
wherein the first finger guide and the second finger guide are molded to the flexible, positioning handle section.
